(19) United States
(12) Patent Application Publication
(10) Pub. No.: US 2005/0140922 A1
(43) Pub. Date: Jun. 30, 2005

(54) Apparatus and method for eyesight rehabilitation

(76) Inventors: Josef Bekerman, Haifa (IL); Anatoly Bekkerman, Haifa (IL)

Correspondence Address: Angenehm Law Firm, Ltd., P.O. Box 48755, Coon Rapids, MN, 55448-0755, US

(21) Appl. No.: 11/071,610

(22) Filed: Mar. 3, 2005

(30) Foreign Application Priority Data
Sep. 4, 2002 (IL) 151592

(51) Int. Cl. G02C 1/00

(52) U.S. Cl. 351/41

(57) ABSTRACT

The invention provides apparatii and methods for eyesight rehabilitation using optical devices having controllable optic power for improving the eyesight of a user. The optical device comprises liquid lenses having curvature that changes in accordance with the amount of transparent liquid confined within the lenses. Changes in the inclination of the users head causes, by physical means or sensors, the curvature of the liquid lens to change while rendering the liquid lenses autofocus features. Lenses made of electroactive material can be used also in order to control the optical power of the lens. According to the method used, the user wearing the lenses is challenged to look at objects positioned in different locations for a predetermined time. The time in which the lenses are focused is adjusted to be slightly longer than the natural accommodation of the users eyes when he turns from one object to the other.

### FIELD OF THE INVENTION

The present invention relates to devices and methods for improving eyesight. More particularly, the present invention relates to spectacles of variable optical power used for rehabilitation of the users eyesight and method of using the spectacles in order to improve the eyesight.

### BACKGROUND OF THE INVENTION

Most people wear glasses due to an error in the focal features of the eyes or, in other words, the ability to focus, which is termed also as amplitude of accommodation. The ability of the eye to focus is accomplished by the lens. The lens is a transparent structure in the eye that focuses the rays of light entering through the pupil. The rays are focused on the retina. The ability to focus is associated with the fact that the lens has the ability to change its shape; hence, its curvature. The ciliary muscles, which are located in the ciliary body, control the lens curvature by relaxation and contraction. The zonular fibers, which are regulated by the muscles as well, laterally support the lens to the circumferential ciliary muscle.

Besides disorders such as myopic eye, hyperopic eye or lens astigmatism, 99% of the population suffers from presbyopia, which is a loss of focusing ability with age, after the age of 40. The problems that are associated with some types of vision defects of children as well as adults are concerned with the failure to accommodate the lens. Generally, these types of impairments is induced by overwork or overstrain of eye's muscles, the ocular muscles, in time of school attending, reading, working on a computer, and so on.

Most of the population suffering from eyes disorders wears spectacles or contact lenses in order to correct the disorder. A combination of disorders may complicate the use of spectacles since certain lens has to be used for far-vision and another one for near-vision while contact lenses fail to correct the disorder. If the user wears spectacle, it is possible to use lenses that are bifocal, trifocal or even multifocal. These available solutions are not sufficient for most people that need to shift quickly the visual attention from near to far objects, for example, during driving a car. Moreover, bifocal, trifocal and even multifocal eyeglasses have dead-zones and limited field of vision for close and middle distances. The users still have a feeling of permanent discomfort.

All the conventional spectacles have a major disadvantage; since the lenses are static, they stop the natural accommodation of the eyes. When using such eyeglasses, the ocular muscles go through muscular dystrophy and the accommodation features progressively fail. In order to exercise the ocular muscles, different methods had been developed. The well-known Bates method, which was invented by W. H. Bates in 1920, combines some philosophic conceptions and system of exercise for the eyes which aimed at releasing the eyes from “visual strain”. Other training methods also exist. All the methods involving exercises need the attention of a skilled ophthalmologist and take a long period of time to improve the eyesight at some extent.

It has been shown over the years that accommodation stimulates convergence. Most clinicians assume that accommodation falls to zero when an emmetropic eye or an adequate corrected ametropic eye fixates a distant object. (from “Visual Optics and Refraction a Clinical Approach, D. D. Michaels, the C. V Mosby Company, USA, 1975).

The need to constantly shift from far-vision to near-vision and to look at objects positioned at different distances brought about the solution of universal eyeglasses or auto-focusing eyeglasses or eyeglasses having lenses with adjustable focal distance. Some spectacles that have some extent of auto-focusing features were developed over the last decades. One example given herein as a reference is U.S. Pat. No. 5,182,585 by Stoner “Eyeglasses with Controllable Refracting Power”. This patent discloses eyeglasses equipped with liquid lenses having adjustable refractive power that depends on the amount of liquid forced into each lens. An electrically powered pump and an electronic controller regulate the liquid input to the lenses in response to a signal determined by the focal length required for viewing a given object in the field of vision. This focal length is determined by the use of a rangefinder mounted on the rim of the eyeglasses. The system is programmed for automatic response tailored to the specific eyesight of the wearer. Another example is disclosed in U.S. Pat. No. 4,181,408 by Senders “Vision Compensation”. The disclosed vision compensation system includes a lens receiving rim with a pair of lens members, at least one of which has variable optical compensation capabilities. Carried by the rim are means for producing a signal as a function of the relative angular positions of the eyes of the wearer and means responsive to that signal for changing the optical characteristics of the variable lens to provide compensation for impaired accommodative capacity of the wearer's eye.

Honigsbaum disclosed in U.S. Pat. No. 4,261,655 “Biomechanically Focused Eyeglasses” an improved biomechanically focused eyeglasses for facial wear that comprise a rim, adjustable focus lenses, means for securing the lenses to the rim, means for adjusting the focus of the lenses, and means for actuating the adjusting means in response to a voluntary anatomical action which does not involve the hands. In an embodiment wherein the adjustable focus lenses comprise liquid filled cells, each having an elastic surface, means for equalizing the fluid volumes which effect focus of the cells is disclosed. An improved variable focus lens is also disclosed.

In mid 2001, a series of articles concerning the development of autofocus eyeglasses were published (“Smart Glasses: Computerized Lenses Come into Focus”, by Anne Eisenberg, International Herald Tribune, Internet addition, 30.6.01; “Optical Scientists to Develop Eyeglasses with Autofocus”, from news release publishes by the University of Arizona, Internet link—http:/www.sciencedaily.com/releases/2001/07/010730080847.htm,7.1.01; “Autofocus Glasses Under Development” by K. Robinson, Photonics Technology internet website www.Photonics.com, October 2001). The variable focus glasses that are under development are adapted in principle to emit an infrared beam to the object a person is looking at. A microprocessor will calculate the power needed to bring the object into focus similarly to an autofocus camera system. An electroactive material such as a polymer or a liquid crystal will be embedded in the eyeglass lens so voltage can be used to control how light is bent at all points across the lens within milliseconds.

All the available solutions referred to herein as references are complicated and expensive solutions that do not provide solution for exercising the accommodation of the eyes; hence do not provide a solution for improving the eyesight and rehabilitating the eyes.

### SUMMARY OF THE INVENTION

It is an object of the present invention to provide a new and unique optical device for rehabilitating the eyesight and improving the vision.

It is yet another object of the present invention to provide new and unique spectacles having lenses with adjustable optical power. The adjustment means of the lens's focus is the positioning of the spectacles in space.

Additionally, it is another object of the present invention to provide a new, simple, and effective method of controlling optical power of spectacle's lenses using native human reflexes or sensors such as inclination sensor.

It is yet another object of the present invention to provide new and unique spectacles that are used for activating the ocular muscles so that after a relatively short period of exercising, the eyesight is markedly improved.

In addition, it is an object of the present invention to provide a new method of rehabilitation of the eyesight by providing spectacles having an adjustable autofocus. The time in which the focus is automatically adjusted is slightly longer than the time of natural accommodation of the human eye so that the user trains the ocular muscles until focus is achieved by the lenses.

It is thus provided in accordance with a preferred embodiment of the present invention eyesight rehabilitation optical device for improving the eyesight of a user, said optical device comprises:
at least one liquid lens of two liquid lenses, each liquid lens comprises two juxtaposed transparent membranes that confine an amount of transparent liquid in a gap between said two juxtaposed transparent membranes, wherein at least one of said two juxtaposed transparent membranes is elastic membrane having changeable curvature that changes upon change in the amount of transparent liquid;
a rim for supporting said at least one liquid lens of two liquid lenses opposite an eye of the user;
two shafts provided on said rim, wherein at least one shaft of said two shafts is provided with a cavity that is fluidically connected to said gap in the liquid lens that resides next to said at least one shaft, and wherein said cavity is provided with additional transparent liquid;
a flexible container that is connected to said at least one shaft, wherein said flexible container is fluidically connected to said cavity;
whereby portions of said additional transparent liquid adds up to the amount of transparent liquid in the gap between said two juxtaposed transparent membranes upon changes in the inclination of the two shafts from substantially horizontal position to a position in which the liquid lens is downwardly moved, and wherein when the user wears the optical device and inclines his head forwards, the curvature of the liquid lens is changed while rendering the liquid lenses autofocus features.

Furthermore, in accordance with another preferred embodiment of the present invention, said two juxtaposed transparent membranes are elastic membranes having changeable curvature that changes upon change in the amount of transparent liquid.

Furthermore, in accordance with another preferred embodiment of the present invention, each one of said two shafts is provided with a protective cup that contains said flexible container, said protective cup is provided with an opening so as to equalize the pressure in said protective cup to an atmospheric pressure.

Furthermore, in accordance with another preferred embodiment of the present invention, said rim is spectacle-like rim.

Furthermore, in accordance with another preferred embodiment of the present invention, said rim is provided with an adjustable bridge so as to adjust an adequate distance between the two liquid lenses.

Furthermore, in accordance with another preferred embodiment of the present invention, said transparent liquid is a viscose liquid.

Furthermore, in accordance with another preferred embodiment of the present invention, said viscose liquid can be selected from a group of glycerin and silicone oil.

Furthermore, in accordance with another preferred embodiment of the present invention, said rim is adapted to seal a circumference of said two juxtaposed transparent membranes so as to prevent liquid leakage.

Furthermore, in accordance with another preferred embodiment of the present invention, said rim is provided with two recesses and wherein said circumference of said two juxtaposed transparent membranes is held in said recesses.

Furthermore, in accordance with another preferred embodiment of the present invention, said two juxtaposed transparent membranes are made of polycarbonate.

Furthermore, in accordance with another preferred embodiment of the present invention, said two juxtaposed transparent membranes have an index of refraction that is substantially the same as an index of refraction of said transparent liquid.

Furthermore, in accordance with another preferred embodiment of the present invention, the width of each one of said two juxtaposed transparent membranes is about 0.17 and 0.20 mm.

Furthermore, in accordance with another preferred embodiment of the present invention, each liquid lens has a diameter of about 40 mm.

Furthermore, in accordance with another preferred embodiment of the present invention, said cavity is fluidically connected to the gap by a tubing adaptor.

Furthermore, in accordance with another preferred embodiment of the present invention, said flexible container is made of an elastic or rubbery material.

Furthermore, in accordance with another preferred embodiment of the present invention, at least one optical lens is provided adjacent to at least one lens of two liquid lenses in order to increase the optical power of the optical device and wherein a bore is provided in said rim so as to allow air to enter or exit a gap between said at least one optical lens and said at least one lens of two liquid lenses.

Furthermore, in accordance with another preferred embodiment of the present invention, at least one lens is provided adjacent to at least one lens of two liquid lenses in order to protect said two juxtaposed transparent membranes.

In accordance with yet another preferred embodiment of the present invention, it is provided eyesight rehabilitation optical device having a rim for supporting lenses and two shafts provided on the rim for supporting the optical device on a head of a user, the optical device is adapted for improving the eyesight of the user, said optical device comprises:
at least one liquid lens of two liquid lenses, each liquid lens comprises two juxtaposed transparent membranes that confine an amount of transparent liquid in a gap between said two juxtaposed transparent membranes, wherein at least one of said two juxtaposed transparent membranes is elastic membrane having changeable curvature;
liquid reservoir that is fluidically connected to said gap;
a pump adapted to transfer liquid between said gap and said liquid reservoir;
an inclination sensor adapted to sense the inclination of the optical device in respect with a horizontal axis;
a pump control unit adapted to receive data from said inclination sensor and to activate said pump according to the data;
a control unit adapted to control time in which said pump is activated;
whereby upon an indication on a forward inclination of the users head from said inclination sensor, liquid from the liquid reservoir adds up to the amount of transparent liquid in the gap between said two juxtaposed transparent membranes, and changes the curvature of the liquid lens while rendering the lens autofocus features.

Furthermore, in accordance with another preferred embodiment of the present invention, at least one optical lens is provided adjacent to at least one lens of two liquid lenses in order to increase the optical power of the optical device and wherein a bore is provided in said rim so as to allow air to enter or exit a gap between said at least one optical lens and said at least one lens of two liquid lenses.

Yet, in accordance with yet another preferred embodiment of the present invention, it is provided eyesight rehabilitation optical device for improving the eyesight of a user, said optical device comprises:
two connected variable optical power lenses;
two shafts provided on said two connected variable optical power lenses for supporting the device on a head of the user;
an adjusting means adapted to modify the optical power of said variable optical power lenses;
an inclination sensor adapted to sense the inclination of the optical device in respect with a horizontal axis;
a microprocessor adapted to receive data from said inclination sensor and to activate said adjusting means according to the data;
a control unit adapted to control the time in which said adjusting means is activated in order to change the optical power of the variable optical power lenses;
whereby upon an indication from said inclination sensor due to inclination of the user's head, said adjusting means is activated, modifying the optical power of the variable optical power lenses, rendering the lenses autofocus features.

Furthermore, in accordance with another preferred embodiment of the present invention, said control unit is integrated with said microprocessor.

Furthermore, in accordance with another preferred embodiment of the present invention, said variable optical power lenses is made of an electroactive material and said adjustable means is an adjustable power supply.

Furthermore, in accordance with another preferred embodiment of the present invention, said electroactive material is a liquid crystal.

Furthermore, in accordance with another preferred embodiment of the present invention, wherein said adjustable power supply is adapted to adjust the voltage that passes through said variable optical power lenses so as to change the optical power of the lens.

Furthermore, in accordance with another preferred embodiment of the present invention, said optical device is provided with spectacle-like rim that supports the variable optical power lenses.

It is thus provided in accordance with yet another preferred embodiment of the present invention a rehabilitation method for restoring deteriorated eyesight of a user having eyes with natural lens accommodation time, said method comprises:
providing an optical device comprising
   two liquid lenses, each liquid lens of said two liquid lenses comprises two juxtaposed transparent membranes that confine an amount of transparent liquid in a gap between said two juxtaposed transparent membranes, wherein at least one of said two juxtaposed transparent membranes is elastic membrane having changeable curvature that changes upon change in the amount of transparent liquid;
   a rim for supporting said two liquid lenses;
   two shafts provided on said rim, wherein each one of said two shafts is provided with a cavity that is fluidically connected to the gap of the liquid lens that resides next to the shaft, and wherein said cavity is provided with additional transparent liquid;
   a flexible container is fluidically connected to said cavity;
wearing said optical device opposite the eyes of the user while the user is looking at a distant object;
adjusting the two liquid lenses so that an optical axis of said two liquid lens coincide with an optical axis of the eyes;
challenging the user to look at different objects that are positioned in different locations for a predetermined time;
whereby when the user inclines his head forward in order to observe close objects, the additional transparent liquid from the cavity is transferred into said gap in a predetermined rate so as to change the optical power of the liquid lenses and vice versa and assure that the time in which the two liquid lenses are focused is slightly longer then the natural accommodation of the user's eyes.

Furthermore, in accordance with another preferred embodiment of the present invention, the method is further provided with providing at least one constant optical lens and positioning said at least one constant optical lens adjacent to said liquid lens.

It is also provided in accordance with yet another preferred embodiment of the present invention a rehabilitation method for restoring deteriorated eyesight of a user having eyes with natural lens accommodation time, said method comprises:
providing an optical device comprising
   two liquid lenses, each liquid lens of said two liquid lenses comprises two juxtaposed transparent membranes that confine an amount of transparent liquid in a gap between said two juxtaposed transparent membranes, wherein at least one of said two juxtaposed transparent membranes is elastic membrane having changeable curvature that changes upon change in the amount of transparent liquid;
   a rim for supporting said two liquid lenses;
   two shafts for supporting said optical device on a head of the user;
   liquid reservoir that is fluidically connected to said gap;
   a pump adapted to transfer liquid between said gap and said liquid reservoir;
   an inclination sensor adapted to sense the inclination of the optical device in respect with a horizontal axis;
   a pump control unit adapted to receive data from said inclination sensor and to activate said pump according to the data;
   a control unit adapted to control time in which said pump is activated;
wearing said optical device opposite the eyes of the user while the user is looking at a distant object;
adjusting the two liquid lenses so that an optical axis of said two liquid lens coincide with an optical axis of the eyes;
challenging the user to look at different objects that are positioned in different locations for a predetermined time;
whereby when the user inclines his head forward in order to observe close objects, the pump control unit that receives information on the inclination of the users head from said inclination sensor activates the pump to push transparent liquid from the reservoir into said gap in a rate so that the desired optical power is achieved during a time that is slightly longer then the natural lens accommodation time.

It is thus provided in accordance with yet another preferred embodiment of the present invention a rehabilitation method for restoring deteriorated eyesight of a user having eyes with natural lens accommodation time, said method comprises:
providing an optical device comprising
   two connected variable optical power lenses;
   two shafts provided on said two connected variable optical power lenses for supporting the device on a head of the user;
   a adjusting means adapted to modify the optical power of said variable optical power lenses;
   an inclination sensor adapted to sense the inclination of the optical device in respect with a horizontal axis;
   a microprocessor adapted to receive data from said inclination sensor and to activate said adjusting means according to the data;
   a control unit adapted to control the adjusting means in changing the optical power of said variable optical power lenses so as to adjust the time in which said adjusting means is activated in order to change the optical power of the variable optical power lenses;
wearing said optical device opposite the eyes of the user while the user is looking at a distant object;
adjusting the two liquid lenses so that an optical axis of said two liquid lens coincide with an optical axis of the eyes;
challenging the user to look at different objects that are positioned in different locations for a predetermined time;
whereby when the user inclines his head forward in order to observe close objects, the control unit that receives information on the inclination of the user's head from said inclination sensor and microprocessor activates the adjusting means so as to change the optical power of said variable optical power lenses in a rate so that the desired optical power is achieved during a time that is slightly longer then the natural lens accommodation time.

Furthermore, in accordance with another preferred embodiment of the present invention, said variable optical power lenses are electroactive lenses and wherein said adjusting means is an adjustable power supply.

Furthermore, in accordance with another preferred embodiment of the present invention, said electroactive lenses are made from a liquid crystal.

### BRIEF DESCRIPTION OF THE FIGURES

FIG. 1 illustrates an isometric view of rehabilitation spectacles in accordance with a preferred embodiment of the present invention.

FIG. 2a illustrates a cross sectional side view of the rehabilitation spectacles shown in FIG. 1, in a position in which the spectacle's shaft is horizontal.

FIG. 2b illustrates a cross sectional view of the spectacles shown in FIG. 2a, in a position in which the spectacle's shaft is inclined in a predetermined angle with respect to the horizontal axis.

FIG. 3a illustrates a cross sectional side view of the rehabilitation spectacles in accordance with another preferred embodiment of the present invention, in a position in which the spectacle's shaft is horizontal.

FIG. 3b illustrates a cross sectional view of the spectacles shown in FIG. 3a, in a position in which the spectacle's shaft is inclined in a predetermined angle with respect to the horizontal axis.

FIG. 4 illustrates the dependence of the optical power and the distance of a focused object from the eye with the inclination angle α of the spectacles in accordance with a preferred embodiment of the present invention.

FIG. 5 illustrates the variation in the inclination of a users head in respect with the distance towards which he is looking at a focused object in accordance with a preferred method of the present invention.

FIG. 6 illustrates device and method for liquid lens's optical power control in accordance with a preferred embodiment of the present invention.

FIG. 7 illustrates device and method for variable lens's optical power control in accordance with another preferred embodiment of the present invention.

### DETAILED DESCRIPTION OF THE INVENTION AND THE FIGURES

The present invention provides a new and unique optical device for rehabilitation of the eyesight and improving the vision by exercising the ocular muscles. It is well known that one of the common disorders of the eyes is failure in accommodating the eye's lens due to weakening of the ocular muscles, especially with age. Using spectacles in order to improve the vision of object situated near or at far is mostly popular; however, it does not improve the eyesight of the user. Improving and rehabilitating the eyesight can be performed by strengthening the ocular muscles, which contract and relaxes the lens, so as to change the lens's curvature and its ability to focus.

According to one aspect of the present invention, exercising the ocular muscles, hence training the eyesight, is performed by wearing an autofocus spectacles. The autofocus spectacles of the present invention comprise of spectacles-like rim having two liquid lenses. The liquid in the lenses is confined between two membranes. The membranes have a curvature that is adjusted according to the amount of liquid in the lens, which depends on the inclination of the spectacles. The positioning of the lens is determined by the inclination of the user's head as will be comprehensively explained herein after. When the user is looking at far objects, his head is mostly straight and the lenses that are positioned on his nose are substantially perpendicular with respect to an imaginary horizontal axis. On the other hand, when the user is reading, for example, he is looking at near objects and leans his head forward. Accordingly, the lenses are inclined so as to establish an angle with respect to the imaginary horizontal axis that is smaller than 90 degrees. It is assumed that the inclination of the user's head accords the distance of an object on which the user is observing and is determined by a spontaneous effect. In another aspect of the present invention, the inclination of the spectacles is sensed by an inclination sensor.

The natural accommodation of the eyes is constant; there is a constant time in which the lens of the eye acquires the curvature by which the image of an object on the retina is focused. Spectacles having regular correction lenses, bifocal lenses, trifocal lenses, or even multifocal lenses are static—the focus of the lenses is constant at all times. In auto-focus lenses, the time in which the lenses acquire focus is relatively short so that the user will be able to instantly see clearly when turning from one object to another. Correction lenses in principle do not encourage the ocular muscles to operate and in fact, the accommodation features of the eyes progressively fail.

In the spectacles according to the present invention, the time characteristic by which the lens acquires focus can be controlled and can be maintained to be slightly longer than the time of natural accommodation of the user's eyes. In this text, the phrase “natural accommodation of the eyes” is referred to the time in which a focused picture having an optimal quality is attained on the retina. In this way, the spectacles can be used for eyes exercising in order to rehabilitate the eyesight rather than for immediate improvement of the vision. It is well known that the eyesight of people wearing eyeglasses does not improve and even deteriorates with time although their immediate vision is improved. By using the spectacles of the present invention, the user eyesight is improved with time as well as his vision due to natural training of the ocular muscles. The different accommodation times of the spectacle's lenses and the eye's lenses impose the user to exercise his ocular muscles without even being aware of it. After relatively short time (a few weeks) the user eyesight is already improved. In according to one aspect of the present invention, the method of controlling the lens's optical power is by controlling the time by which the liquid lens gains focus of a certain object at which the user observes. In another aspect of the present invention, the optical device comprises variable optical power lens such as lenses embedded with electroactive material. In this case, a microprocessor controls the power supply to the lens; hence, its optical power. In any of the methods used in the present invention, the time in which focus of the variable lens is acquired is slightly longer then the time of natural accommodation.

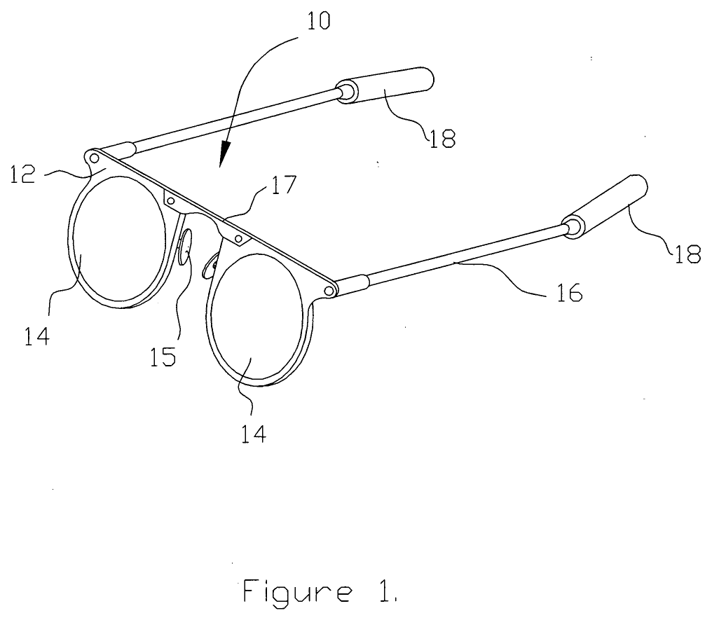

Reference is now made to FIG. 1 illustrating an isometric view of rehabilitation spectacles in accordance with a preferred embodiment of the present invention. Rehabilitation spectacles 10 comprise a spectacle-like rim 12 for wearing the spectacles on a user's nose and for retaining lenses opposite the user's eyes. Two liquid lenses 14 are provided in rim 12. The liquid, which may be a viscose liquid such as glycerin or silicone oil, is confined between two membranes that are held at their circumference in a corresponding recess (not shown in FIG. 1) in rim 12. The membranes, which may be made from polycarbonate, for example, are elastic membranes that are adapted to change their curvature. It is important to note that the index of refraction of both the liquid and the membranes has to be substantially of the same magnitude in order to establish a lens having substantially constant index of refraction at any location along the membrane thickness and eliminate refraction distortions. It is optional to use only one elastic membrane.

Exemplary preferred dimensions for the spectacles of the present invention that are optimal are given for spectacles with liquid lenses in which the liquid is glycerin or the viscosity of the liquid is substantially the same as the viscosity of glycerin. In this case, the thickness of the membrane should preferably be of about 0.17-0.20 mm and the diameter of the lens should preferably be about 40 mm. It should be noted that any other dimensions or liquid that are used in the spectacles of the present invention is covered by the scope of the present invention.

Since the membranes are made from an elastic material, the curvature of the lens is adjustable and is determined by the pressure of the liquid confined between the membranes that push the membranes outwardly. As the pressure of the liquid is greater, the curvature of the liquid lens is higher. The adjustment of the membranes curvature in fact varies the optical power of the lens. The optical power of the lenses is expressed in diopters (D), which is defines as an optical unit representing the reciprocal of the focal length (in meters) of a lens, in terms of meters. One diopter lens has a focal length of one meter, two diopter lens has a focal length of ½ meter, etc.

Since liquid lenses 14 have to be positioned exactly opposite the eyes of the user and users have different face shapes, an adjustable bridge 17 is provided between lenses 14 and connects the two parts of spectacle's rim 12. The distance between the two parts of rim 12 can be adjusted using bridge 17. Nosepads 15 are provided on rim 12 on order to uphold the spectacles opposite the eyes.

Rehabilitation spectacles 10 further comprise two shafts 16 that are provided at both sides of rim 12 and are designated to support the spectacles on the users head. Shafts 16 of the spectacles of the present invention have another important role. Each shaft 16 is hollow while the interior cavity 17 in each shaft is fluidically connected to the liquid in the lens resides next to the shaft. Shafts 16 act as liquid reservoirs that are adapted to allow the change in pressure in liquid lenses 14. Each one of shafts 16 is provided with a protective cup 18 containing flexible container (not shown in FIG. 1), and act as an earpiece.

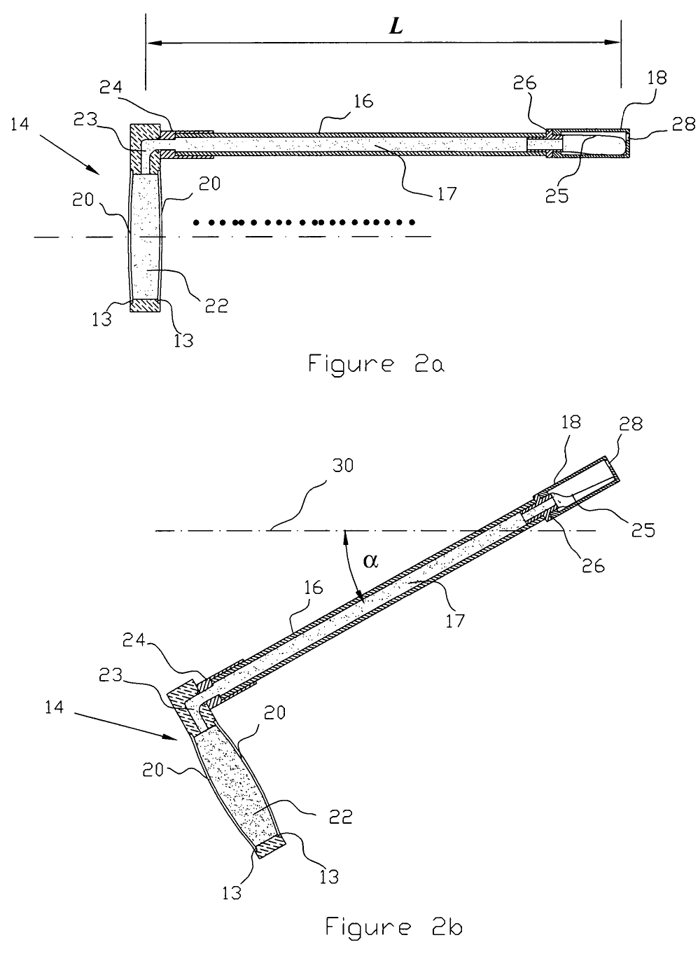

In order to better understand the mechanism on which the adjustable spectacles of the present invention is based, reference is now made to FIG. 2a illustrating a cross sectional side view of the rehabilitation spectacles shown in FIG. 1, in a position in which the spectacle's shaft is horizontal. Liquid lens 14 comprises of two juxtaposed membranes 20 that are spaced in their circumference since they are inserted in two spaces recesses 13 in the circumference of rim 12 so as to define a gap 22 between the membranes. Membranes 14 are cemented or welded to rim 12 so as to establish a leak-proof connection. Gap 22 is filled with relatively viscose and transparent liquid such as glycerin. Cavity 17 is fluidically connected by a tubing adaptor 24 at one side to gap 22 through a channel 23 at the endpiece of rim 12. Cavity 17 in hollow shaft 16 is also filled with the same liquid as gap 22. Hollow shaft 16 is provided at the other end with a flexible container 25 that is also filled with the same liquid, and is connected to shaft 16 by an adapter 26. Flexible container 25 is preferably made from an elastic or rubbery material. Protective cup 18 is connected to shaft 16 and covers flexible container 25. Protective cup 18 protects the elastic material of flexible container 25 and limits the amount of liquid that can be withdrawn into flexible container 25 from cavity 17 of the hollow shaft and gap 22 between the membranes. Protective cup 18 is provided with an opening 28 that equalizes the pressure inside the protective cup to the atmospheric pressure. It is noted that the liquids in gap 22, cavity 17 and flexible container 25 are fluidically connected and establish a closed system.

Cavity 17 and flexible container 25 are liquid reservoirs that are adapted to allow changes in the pressure inside gap 22. The pressure in gap 22 depends on the height of the liquid column in hollow shaft 16. In the horizontal position shown in FIG. 2a, since shaft 16 is horizontal, the liquid in the reservoir does not have a significant affect on the pressure inside gap 22. The pressure in gap 22 is adjusted so that the curvature of membranes 20 is substantially zero; hence having zero diopters at the optical axis of the lens.

Reference is now made to FIG. 2b illustrating a cross sectional view of the spectacles shown in FIG. 2a, in a position in which the spectacle's shaft is inclined in a predetermined angle with respect to the horizontal axis. Inclining shaft 16 while lens 14 is downwardly positioned causes the height of the liquid in the reservoir to be higher, therefore the pressure of the liquid in gap 22 is increased and the curvature of the membranes becomes greater. In fact, the initial pressure in gap 22 is controllable and is determined by an initial amount of liquid filled in gap 22. The stretch forces exerted on the membranes from the liquid side is equilibrated by external atmospheric pressure P₀ and an extra initial pressure ΔP generated by flexible container 25. When hollow shaft 16 having a length L is inclined by an angle α, as shown in FIG. 2b, the pressure P in the lens's gap is increased by reasons of increasing the height of the liquid column in accordance with the following relation:
P=(P₀+ΔP)+ρgL sin α
Where ρ is the density of the liquid in the reservoir and the gap, and g is free fall acceleration. In a first approximation, it can be expected a linear dependence between a radius of curvature of the membrane and the pressure P inside the lens.

There is a distinct correlation between the inclination angle of hollow shaft 16 and the curvature of liquid lens 14; hence, the optical power of the lens that can be expressed also in diopters, is as follows:

$$D ( α ) = \frac{2 \cdot ( n - 1 )}{{R}_{0} + k \cdot ( ρ gL sin α )}$$

where R₀ is the initial radius of curvature of the elastic lens and k is a constant value depending on the membrane's properties. In an experimental spectacles built by the inventors, the values for R₀ and k were determined to be R₀=0.91 [m]; k=2.2507×10⁻⁴ [m/mmHg].

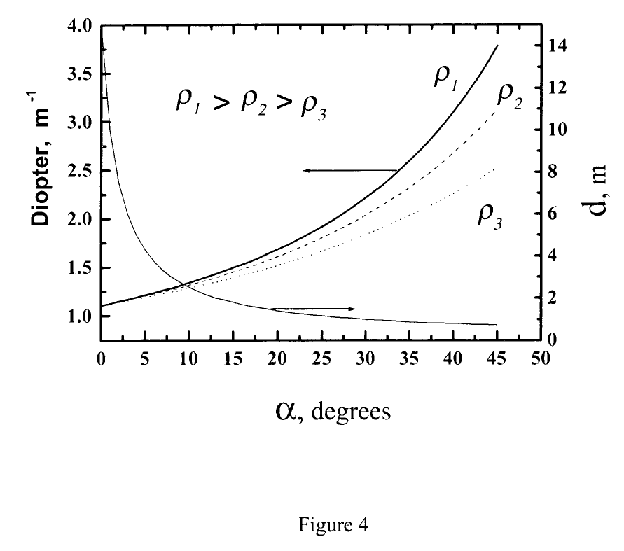

Reference is now made to FIG. 4 illustrating the dependence of the optical power and the distance of a focused object from the eye with the inclination angle α of the spectacles in accordance with a preferred embodiment of the present invention. The figure depicts a family of optical power dependencies of liquid-filled lens on the angle of inclination of the spectacles in regard with the imaginary horizontal axis. It is clearly shown that from a horizontal position of the spectacles shaft; hence α=0°, to inclination of about 45°, the amplitude of optical power can reach ΔD=2.5 m⁻¹. If the user wears spectacles that have higher diopter such as 5D, for example, a constant lens of another 2.5D should be added adjacent to the liquid lens.

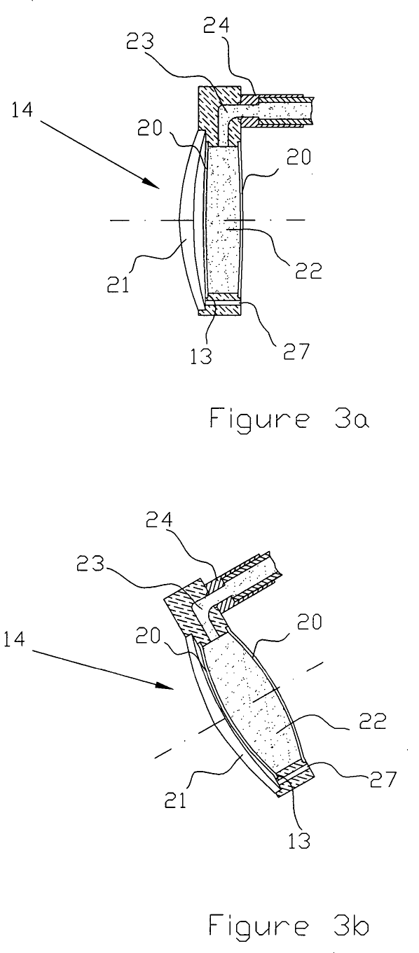

Reference is now made to FIGS. 3a and 3b illustrating cross sectional side views of the rehabilitation spectacles in accordance with another preferred embodiment of the present invention, in a position in which the spectacle's shaft is horizontal and in a position in which the spectacle's shaft is inclined in a predetermined angle with respect to the horizontal axis, respectively. In principle, the embodiment shown in FIGS. 3a and 3b is similar to the embodiment shown in FIGS. 2a and 2b. The embodiment in FIGS. 3a and 3b is further provided with a constant lens 21 that is positioned adjacent to liquid lens 14. Constant lens 21 may be an optical lens that is adapted to increase the optical power of the liquid lens or may be a lens that is adapted solely to protect the membranes of the liquid lens. Constant lens 21 is preferably curved so as to enable liquid lens 14 to change its curvature without disturbance when the spectacles are inclined, as shown in FIG. 3b. Addition of other constant lenses is also covered by the scope of the present invention. In order to allow liquid lens 14 to curve towards constant lens 21, an bore 27 to allow air from the gap between the constant and liquid lenses to enter and exit is provided.

It should be noted that in accordance with the rehabilitation spectacles of the present invention, there are a few variables that can be selected in order to adjust the specific spectacles to a specific user. Examples for parameters that can be selected are the length of the shafts, the liquid inside the gap that forms the liquid lens, the amount of liquid initially inserted inside the gap and the type of membrane.

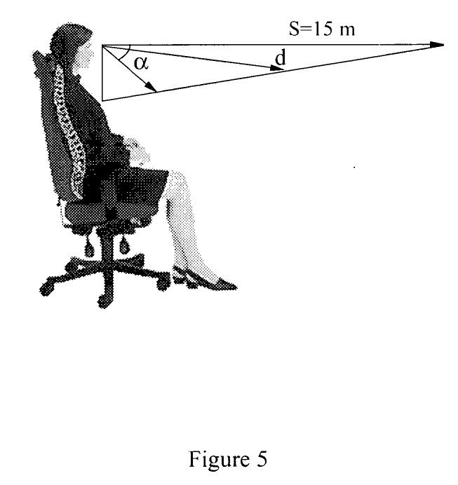

Another parameter depends on the inclination angle, the distance (d) of a focused object from the user's eyes. Reference is now made to FIG. 5 illustrating the variation in the inclination of a user's head in respect with the distance towards which he is looking at a focused object in accordance with a preferred method of the present invention. Inclining the shaft is naturally caused by inclining the user's head. If the user observes objects that are in a far distance, his head is substantially straight and the shafts of the spectacles are substantially horizontal. When the user looks at near-by objects, he inclines automatically his head forward and the spectacles reach a position such as the position shown in FIG. 2b. The angle α, which is defined as the angle between an imaginary horizontal axis 30 and shaft 16 is adjusted according to the user's head position. According to the dependency of the distance d of a focused object from the user's eye as shown in FIG. 4, FIG. 5 illustrates a user that observes objects through the spectacles of the present invention and the dependence of the distance d with the angle in which he inclines his head.

In the method of the present invention, the spectacles are adjusted so as to establish focus on an object the user is observing according to the inclination of the users head. In order for the user to exercise his ocular muscles and improve his eyesight, the user has to wear the spectacles of the present invention so that the optical axis of each liquid lens coincides with the optical axis of the corresponding eye. This can be performed by looking at a distance d which is longer than about 15 m; hence, holding his head substantially straight. The user should adjust the spectacles one eye at a time while the other eye is closed. The initial pressure of liquid in the corresponding lens is adjusted by forcing an extra amount of liquid in flexible container 25 (FIG. 2a) until the user can clearly observe the distant object. After adjustment of both lenses, the user should see clear objects in the range from zero inclination of his head (straight positioning of the head) to about 45° inclination of his head (reading position).

As mentioned herein before, in the spectacles of the present invention, the time in which the spectacles gain auto-focus on an object is slightly longer than the time of natural accommodation of the eyes, e.g. the time in which the ocular muscles accommodate the eye's lens to focus an object on the retina. During the gap between those times, the part of the brain that controls the ocular muscles sends a signal to the muscle to try and acquire focus. In this way, every time the user moves his head in order to look at an object, the ocular muscles are being exercised. It is preferable to exercise the ocular muscles for about 5 to 40 minutes a day. Using the spectacles in the exercise mode for longer times may exert extra stress on the eyes and may inadequately inflict the training effect. Over-exerting the ocular muscles due to other reasons is also not desirable. For example, choosing a time gap between natural accommodation of the eye and gaining auto-focus in the lenses of the spectacles which is to long may cause the ocular muscles to be over-exerted; hence fatigue of the ocular muscles and the eyes may occur. Results for improving eyesight can be achieved in 8 to 14 days already.

According to the method of the present invention, any auto-focus spectacles such as the auto-focus spectacles that are mentioned in the prior art, can be modified and adjusted so as to construct spectacles for exercising the ocular muscles and for rehabilitating the eyesight. As mentioned herein before, the prior art auto-focus spectacles are designated for wearing at all times and are designated for improving the focus of an object either for a near object or for a far one. In regard with improvement of eyesight, the prior art spectacles fail since instead of exercising the ocular muscles, they tend to weaken the ocular muscles, hence weaken the eyesight. In order to establish spectacles for exercising the ocular muscles, the time in which the lenses of the spectacles acquire autofocus conditions is set to be slightly longer than the time of natural accommodation. If the autofocus of the spectacles is achieved using computerized system, for example, a time constant has to be inserted in the computer's programming so that the time for gaining autofocus is predetermined to be longer than the time for natural accommodation of the eyes. Any other controlling system that controls the time for autofocus is covered by the scope of the present invention.

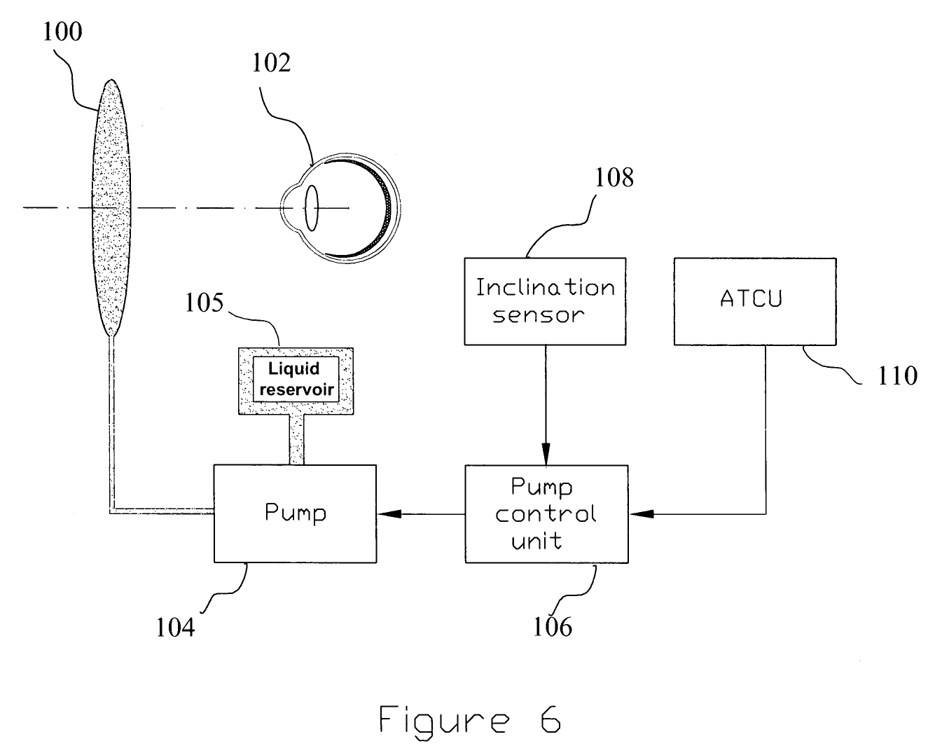

Reference is now made to FIG. 6 illustrating device and method for liquid lens's optical power control in accordance with a preferred embodiment of the present invention. The rehabilitation spectacles that are used in the shown embodiment are based on liquid lenses that are similar to the lenses in the spectacles shown in FIG. 1. Liquid lens 100 is placed opposite the user's eye 102 using standard rim and shafts (not shown in FIG. 6). A pump 104, which is a two directional pump, can force additional liquid into liquid lens 100 or withdraw liquid from it. Additional liquid is provided in a liquid reservoir 105 that is connected to pump 104. Pump 104 is controlled by a pump control unit 106 that receives information from an inclination sensor 108. Inclination sensor 108 can be any type of sensor that may be provided on the spectacles shaft, for example, and senses any movement of the shaft from a horizontal position. Upon an indication of movement from the sensor, the information from inclination sensor 108 is transferred to pump control unit 106 that in turn commands pump 104 to drive liquid into the lens or to withdraw liquid from it according to the position of the spectacle's, which is in accordance with the user's head position, as discussed herein before.

As mentioned herein before, the time for the liquid lens to acquire focus has to be slightly longer than the time of natural accommodation of the eyes in order to exercise the ocular muscles, therefore an accommodation time control unit (ATCU) 110 is provided. Using ATCU 110, the physician that fits the eyeglasses to a specific user can modify the amount of liquid to be transferred into and out from the lenses through ATCU 110 that controls pump control unit 106.

In another aspect of the present invention, the lenses that are used as autofocus lenses may be any other type of lenses that have variable optical power besides liquid lenses. An example may be lenses that are made from an electroactive material such as liquid crystal that responds to an electric field so that the area of the lens is broken up into many small pixels and a different voltage is applied to each pixel.

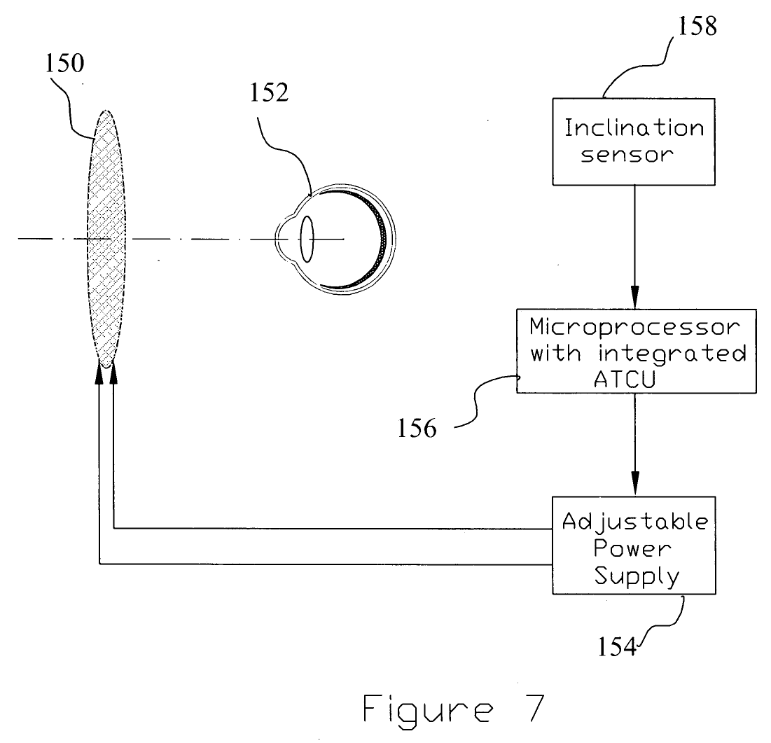

Reference is now made to FIG. 7 illustrating device and method for adjustable lens's optical power control in accordance with another preferred embodiment of the present invention. A lens 150 that has a variable refractive index is placed opposite a user's eye 152 using a rim and shafts, as mentioned herein before. The rim and shafts are not shown in the figures. Lens 150 is provided with an adjustable power supply 154 that affects lens 150 to change its focus. In a preferred embodiment of the present invention, the lens is electroactive. The lenses optical power is changed due to change in the voltage that passes through the lens. The voltage is determined by adjustable power supply 154 that is adjustable by a microprocessor 156 that is provided with an integrated ATCU. Similarly to the method discussed herein before, the physician can control the time that the lens acquires focus in respect with the time for natural accommodation of the eyes in order to enable the ocular muscles to practice during the time gap between focus and accommodation. An inclination sensor 158 that is further provided on the rehabilitation spectacle device indicates microprocessor 156 on the positioning of the spectacles; hence, on the inclination of the user's head as explained herein before. In the preferred method of the present invention, after adjustments of the lens optical power for far-vision, the user is encouraged to observe object positioned at different distances from him for a predetermined time so as to exercise his eyes.

It should be clear that the description of the embodiments and attached Figures set forth in this specification serves only for a better understanding of the invention, without limiting its scope as covered by the following claims.

It should also be clear that a person skilled in the art, after reading the present specification can make adjustments or amendments to the attached Figures and above described embodiments that would still be covered by the following claims.

1. Eyesight rehabilitation optical device for improving the eyesight of a user, said optical device comprises:
at least one liquid lens of two liquid lenses, each liquid lens comprises two juxtaposed transparent membranes that confine an amount of transparent liquid in a gap between said two juxtaposed transparent membranes, wherein at least one of said two juxtaposed transparent membranes is elastic membrane having changeable curvature that changes upon change in the amount of transparent liquid;
a rim for supporting said at least one liquid lens of two liquid lenses opposite an eye of the user;
two shafts provided on said rim, wherein at least one shaft of said two shafts is provided with a cavity that is fluidically connected to said gap in the liquid lens that resides next to said at least one shaft, and wherein said cavity is provided with additional transparent liquid;
a flexible container that is connected to said at least one shaft, wherein said flexible container is fluidically connected to said cavity;
whereby portions of said additional transparent liquid adds up to the amount of transparent liquid in the gap between said two juxtaposed transparent membranes upon changes in the inclination of the two shafts from substantially horizontal position to a position in which the liquid lens is downwardly moved, and wherein when the user wears the optical device and inclines his head forwards, the curvature of the liquid lens is changed while rendering the liquid lenses autofocus features.

2. The optical device as claimed in claim 1, wherein said two juxtaposed transparent membranes are elastic membranes having changeable curvature that changes upon change in the amount of transparent liquid.

3. The optical device as claimed in claim 1, wherein each one of said two shafts is provided with a protective cup that contains said flexible container, said protective cup is provided with an opening so as to equalize the pressure in said protective cup to an atmospheric pressure.

4. The optical device as claimed in claim 1, wherein said rim is spectacle-like rim.

5. The optical device as claimed in claim 1, wherein said rim is provided with an adjustable bridge so as to adjust an adequate distance between the two liquid lenses.

6. The optical device as claimed in claim 1, wherein said transparent liquid is a viscose liquid.

7. The optical device as claimed in claim 6, wherein said viscose liquid can be selected from a group of glycerin and silicone oil.

8. The optical device as claimed in claim 1, wherein said rim is adapted to seal a circumference of said two juxtaposed transparent membranes so as to prevent liquid leakage.

9. The optical device as claimed in claim 8, wherein said rim is provided with two recesses and wherein said circumference of said two juxtaposed transparent membranes is held in said recesses.

10. The optical device as claimed in claim 1, wherein said two juxtaposed transparent membranes are made of polycarbonate.

11. The optical device as claimed in claim 1, wherein said two juxtaposed transparent membranes have an index of refraction that is substantially the same as an index of refraction of said transparent liquid.

12. The optical device as claimed in claim 1, wherein the width of each one of said two juxtaposed transparent membranes is about 0.17 and 0.20 mm.

13. The optical device as claimed in claim 1, wherein each liquid lens has a diameter of about 40 mm.

14. The optical device as claimed in claim 1, wherein said cavity is fluidically connected to the gap by a tubing adaptor.

15. The optical device as claimed in claim 1, wherein said flexible container is made of an elastic or rubbery material.

16. The optical device as claimed in claim 1, wherein at least one optical lens is provided adjacent to at least one lens of two liquid lenses in order to increase the optical power of the optical device and wherein a bore is provided in said rim so as to allow air to enter or exit a gap between said at least one optical lens and said at least one lens of two liquid lenses.

17. The optical device as claimed in claim 1, wherein at least one lens is provided adjacent to at least one lens of two liquid lenses in order to protect said two juxtaposed transparent membranes.

18. Eyesight rehabilitation optical device having a rim for supporting lenses and two shafts provided on the rim for supporting the optical device on a head of a user, the optical device is adapted for improving the eyesight of the user, said optical device comprises:
at least one liquid lens of two liquid lenses, each liquid lens comprises two juxtaposed transparent membranes that confine an amount of transparent liquid in a gap between said two juxtaposed transparent membranes, wherein at least one of said two juxtaposed transparent membranes is elastic membrane having changeable curvature;
liquid reservoir that is fluidically connected to said gap;
a pump adapted to transfer liquid between said gap and said liquid reservoir;
an inclination sensor adapted to sense the inclination of the optical device in respect with a horizontal axis;
a pump control unit adapted to receive data from said inclination sensor and to activate said pump according to the data;
a control unit adapted to control time in which said pump is activated;
whereby upon an indication on a forward inclination of the users head from said inclination sensor, liquid from the liquid reservoir adds up to the amount of transparent liquid in the gap between said two juxtaposed transparent membranes, and changes the curvature of the liquid lens while rendering the lens autofocus features.

19. The optical device as claimed in claim 18, wherein at least one optical lens is provided adjacent to at least one lens of two liquid lenses in order to increase the optical power of the optical device and wherein a bore is provided in said rim so as to allow air to enter or exit a gap between said at least one optical lens and said at least one lens of two liquid lenses.

20. Eyesight rehabilitation optical device for improving the eyesight of a user, said optical device comprises:
two connected variable optical power lenses;
two shafts provided on said two connected variable optical power lenses for supporting the device on a head of the user;
an adjusting means adapted to modify the optical power of said variable optical power lenses;
an inclination sensor adapted to sense the inclination of the optical device in respect with a horizontal axis;
a microprocessor adapted to receive data from said inclination sensor and to activate said adjusting means according to the data;
a control unit adapted to control the time in which said adjusting means is activated in order to change the optical power of the variable optical power lenses;
whereby upon an indication from said inclination sensor due to inclination of the user's head, said adjusting means is activated, modifying the optical power of the variable optical power lenses, rendering the lenses autofocus features.

21. The optical device as claimed in claim 20, wherein said control unit is integrated with said microprocessor.

22. The optical device as claimed in claim 20, wherein said variable optical power lenses is made of an electroactive material and said adjustable means is an adjustable power supply.

23. The optical device as claimed in claim 22, wherein said electroactive material is a liquid crystal.

24. The optical device as claimed in claim 22, wherein said adjustable power supply is adapted to adjust the voltage that pass through said variable optical power lenses so as to change the optical power of the lens.

25. The optical device as claimed in claim 20, wherein said optical device is provided with spectacle-like rim that supports the variable optical power lenses.

26. A rehabilitation method for restoring deteriorated eyesight of a user having eyes with natural lens accommodation time, said method comprises:
providing an optical device comprising
two liquid lenses, each liquid lens of said two liquid lenses comprises two juxtaposed transparent membranes that confine an amount of transparent liquid in a gap between said two juxtaposed transparent membranes, wherein at least one of said two juxtaposed transparent membranes is elastic membrane having changeable curvature that changes upon change in the amount of transparent liquid;
a rim for supporting said two liquid lenses;
two shafts provided on said rim, wherein each one of said two shafts is provided with a cavity that is fluidically connected to the gap of the liquid lens that resides next to the shaft, and wherein said cavity is provided with additional transparent liquid;
a flexible container is fluidically connected to said cavity;
wearing said optical device opposite the eyes of the user while the user is looking at a distant object;
adjusting the two liquid lenses so that an optical axis of said two liquid lens coincide with an optical axis of the eyes;
challenging the user to look at different objects that are positioned in different locations for a predetermined time;
whereby when the user inclines his head forward in order to observe close objects, the additional transparent liquid from the cavity is transferred into said gap in a predetermined rate so as to change the optical power of the liquid lenses and vice versa and assure that the time in which the two liquid lenses are focused is slightly longer then the natural accommodation of the user's eyes.

27. The method as claimed in claim 26, wherein the method is further provided with providing at least one constant optical lens and positioning said at least one constant optical lens adjacent to said liquid lens.

28. A rehabilitation method for restoring deteriorated eyesight of a user having eyes with natural lens accommodation time, said method comprises:
providing an optical device comprising
two liquid lenses, each liquid lens of said two liquid lenses comprises two juxtaposed transparent membranes that confine an amount of transparent liquid in a gap between said two juxtaposed transparent membranes, wherein at least one of said two juxtaposed transparent membranes is elastic membrane having changeable curvature that changes upon change in the amount of transparent liquid;
a rim for supporting said two liquid lenses;
two shafts for supporting said optical device on a head of the user;
liquid reservoir that is fluidically connected to said gap;
a pump adapted to transfer liquid between said gap and said liquid reservoir;
an inclination sensor adapted to sense the inclination of the optical device in respect with a horizontal axis;
a pump control unit adapted to receive data from said inclination sensor and to activate said pump according to the data;
a control unit adapted to control time in which said pump is activated;
wearing said optical device opposite the eyes of the user while the user is looking at a distant object;
adjusting the two liquid lenses so that an optical axis of said two liquid lens coincide with an optical axis of the eyes;
challenging the user to look at different objects that are positioned in different locations for a predetermined time;
whereby when the user inclines his head forward in order to observe close objects, the pump control unit that receives information on the inclination of the users head from said inclination sensor activates the pump to push transparent liquid from the reservoir into said gap in a rate so that the desired optical power is achieved during a time that is slightly longer then the natural lens accommodation time.

29. A rehabilitation method for restoring deteriorated eyesight of a user having eyes with natural lens accommodation time, said method comprises:
providing an optical device comprising
two connected variable optical power lenses;
two shafts provided on said two connected variable optical power lenses for supporting the device on a head of the user;
a adjusting means adapted to modify the optical power of said variable optical power lenses;
an inclination sensor adapted to sense the inclination of the optical device in respect with a horizontal axis;
a microprocessor adapted to receive data from said inclination sensor and to activate said adjusting means according to the data;
a control unit adapted to control the adjusting means in changing the optical power of said variable optical power lenses so as to adjust the time in which said adjusting means is activated in order to change the optical power of the variable optical power lenses;
wearing said optical device opposite the eyes of the user while the user is looking at a distant object;
adjusting the two liquid lenses so that an optical axis of said two liquid lens coincide with an optical axis of the eyes;
challenging the user to look at different objects that are positioned in different locations for a predetermined time;
whereby when the user inclines his head forward in order to observe close objects, the control unit that receives information on the inclination of the user's head from said inclination sensor and microprocessor activates the adjusting means so as to change the optical power of said variable optical power lenses in a rate so that the desired optical power is achieved during a time that is slightly longer then the natural lens accommodation time.

30. The method as claimed in claim 29, wherein said variable optical power lenses are electroactive lenses and wherein said adjusting means is an adjustable power supply.

31. The method as claimed in claim 30, wherein said electroactive lenses are made from a liquid crystal.
